(19) United States
(12) Patent Application Publication
(10) Pub. No.: US 2026/0200416 A1
(43) Pub. Date: Jul. 16, 2026

(54) Component and Motor Vehicle

(71) Applicant: BAYERISCHE MOTOREN WERKE AKTIENGESELLSCHAFT, München (DE)

(72) Inventors: Joachim KRAUSE, Muenchen (DE); Stefan LIESE, Koeln (DE)

(21) Appl. No.: 19/136,960

(22) PCT Filed: Jan. 11, 2024
(86) PCT No.: PCT/EP2024/050519

§ 371 Date: Jun. 9, 2025

(30) Foreign Application Priority Data
Jan. 24, 2023 (DE) 10 2023 101 656.3

(51) Int. Cl. B60R 16/02; H02G 3/22

(52) U.S. Cl. CPC B60R 16/0222; H02G 3/22

(57) ABSTRACT

A component includes at least one opening in which an insert is arranged, wherein the insert has a connecting portion as well as a first functional portion at a first end and a second functional portion at a second end. The functional portions rest against the component on both sides, wherein the connecting portion projects through the opening. The opening has a basic shape which is adapted to a cross-sectional shape of the connecting portion. Extensions formed in pairs extend radially outward from the basic shape in such a way that the diameter of the basic shape is enlarged in certain areas, which makes it easier to insert at least the first functional portion through the opening in order to arrange the insert.

### BACKGROUND AND SUMMARY

The present invention relates to a component, comprising at least one opening in which an insert is positioned, and to a motor vehicle.

Inserts of the type in question are also referred to as grommets or cable bushings. They act, for example, as cut protectors, sealing elements or are used for the (vibration) decoupling of components. In reality, the installation or positioning of inserts of this kind is not without problems. Inserts of this kind need to be securely fitted. In this case, the installation should not be excessively tight, however, and it must be ensured that the insert is not damaged during installation. DE 10 2006 052 213 A1 discloses, in this connection, a grommet with a two-part design. This makes the positioning easier but increases the installation complexity. In addition, a greater cost outlay is to be expected.

An object of the present invention is therefore to provide a component and a motor vehicle, wherein an insert is intended to be positioned in the component reliably and rapidly.

This object is achieved by a component and by a motor vehicle having such a component in accordance with the independent claim(s). Further advantages and features are found in the dependent claims, as well as in the description and the appended figures.

According to the invention, a component comprises at least one opening in which an insert is positioned, wherein the insert has a web and, at a first end, a first functional portion and, at a second end, a second functional portion, wherein the functional portions bear against both sides of the component, wherein the web protrudes through the opening, and wherein the opening has a basic shape, which is adapted to a cross-sectional shape of the web, and wherein extensions formed in pairs extend radially away from the basic shape in such a manner that a diameter of the basic shape is enlarged in certain regions, thus making it easier to guide at least the first functional portion through the opening for positioning the insert.

According to a preferred embodiment, the insert is designed as a cable bushing or a grommet. Preferred materials therefor are in particular plastics or rubber materials. Inserts of this kind are used, for example, for the purpose of sealing off the opening in which they are positioned, wherein they additionally or alternatively can have the purpose of simultaneously making it possible to guide another element through the opening, such as one or more cables, for example. In that case, the insert acts as a cut protector, for example. However, an insert of this kind can also be a rubber bearing that is used to position another component, such as, for example, a shaft that is guided through the insert. Inserts of this kind can also be used to vibrationally decouple two components from one another, etc.

The insert has the functional portions at both ends, which preferably bear in a planar manner against the component. The functional portions have a greater diameter than the web. As a result, guiding the functional portions through an opening that has a diameter adapted to the web is not without problems. Although inserts of this kind typically have a certain softness and/or flexibility, there is the risk of damage possibly occurring in the case of excessive deformation. In addition, installation may take a long time, which can be disadvantageous in terms of the cycle time of the respective process. Advantageously, at least two extensions formed in pairs are then provided, which extend radially away from the basic shape of the opening in such a manner that it is easier to guide at least one of the functional portions through. Expediently, the extensions thus describe a diameter that is larger than a diameter of the basic shape, particularly preferably approximately a diameter that is adapted to the size or the diameter of at least one functional portion.

Typically, the functional portions have the same shape and/or size. Alternatively, they can, however, also have designs of different sizes. Preferably, the functional portions have a plate-like or disk-like design, in particular a circular-disk-like design.

Preferably, the extensions are formed opposite one another. The extensions expediently cause the diameter of the opening to be enlarged in certain regions. Expediently, this can make it easier to guide the one or more functional portions through. Expediently, the extensions cover an angular range of, for example, 5 to 15° in the circumferential direction. However, in relation to the overall circumference of the opening, they are relatively small. This advantageously ensures that the insert is securely fixed in the opening by the web.

According to one preferred embodiment, the extensions have a semi-circular shape. A somewhat rounded contour can in principle have the advantages of preventing damage when guiding the insert through. Alternatively, it can, however, also be advantageous, for example for manufacturing reasons, for the extensions to have a polygonal design, for example in particular a quadrilateral design.

As already mentioned, the functional portions formed at the end sides preferably have a plate-like or circular-disk-like design. When the insert is in the installed state, the functional portions preferably bear in a planar manner against the respective component. The distance between the functional portions expediently corresponds approximately or at least approximately to the thickness of the component in the region of the insert. According to one embodiment, the component can also have a multi-part design. This means that the component has a plurality of component portions or component individual parts, wherein the first functional portion is positioned on a first component portion and the second functional portion is positioned on a second component portion. The opening is accordingly formed by the two component portions, which are positioned one above the other.

Expediently, the functional portions cover the extensions. Expediently, the functional portions are thus configured or dimensioned in such a manner that the extensions are covered and/or sealed off. In other words, the extensions are no longer visible once the insert has been positioned. This ensures that, for example, a sealing action continues to be guaranteed.

According to one embodiment, the opening can also have a plurality of pairs of extensions. This can be expedient in terms of making the positioning or positioning direction of the insert more variable.

According to one preferred embodiment, the insert has at least one cavity extending along a longitudinal axis. As already mentioned, the insert can be expediently used to position other components, to guide other components through, to support other components, or the like. The cavity is conventionally round, in particular circular, but can also have different shapes. The cavity is preferably formed in the center of the web and extends into the functional portions, with the result that a through-opening or a through-hole is formed.

According to one embodiment, the component comprises a plurality of openings, each comprising a pair of extensions, wherein the extensions positioned in pairs are each oriented differently. In the case of three openings, the extensions have, for example, an angular offset of 120° relative to one another, and 90° in each case in the case of four openings, etc. As a result, when the inserts are used to fasten the component, no undesired longitudinal or rotational movement can occur.

According to one preferred embodiment, the component is designed or intended to be used in a motor vehicle. For example, the component is a sheet-metal component and the openings are installation holes, for example for electrical components such as control devices. Expediently, the extensions can be produced or machined using the same manufacturing process as the openings themselves, preferably also in the same work step. It is possible to use stamping therefor, for example.

Advantageously, in the present case, the opening or hole contour of a component is extended by at least two lateral cutouts, referred as extensions in the present case. The width and diameter of the cutouts, as well as the transition radii, are adapted in accordance with the elastically deformed contour of the insert. The cutouts or extensions enable the slightly deformed insert to be threaded without excessive squashing. After the insert has expanded, it is expediently centered in the center by the remaining opening walls. For installation, the insert is, for example, lightly manually pressed. The insert can be inserted in this manner halfway into the hole contour, the part still on the outside is swiveled in and is completely fitted into the opening by means of light pressure from above. The widespread use of grommets of this kind as a common decoupling element and cut protector for cables in through-holes as well as bushings advantageously results in a very large field of use.

The invention is also directed toward a motor vehicle, comprising at least one component according to the invention.

Further advantages and features are found in the following description of one embodiment of an insert and of a component with reference to the appended figures.

### BRIEF DESCRIPTION OF THE DRAWINGS

FIG. 1: shows one embodiment of an insert; and

FIG. 2: shows one embodiment of a component according to the invention.

### DETAILED DESCRIPTION OF THE DRAWINGS

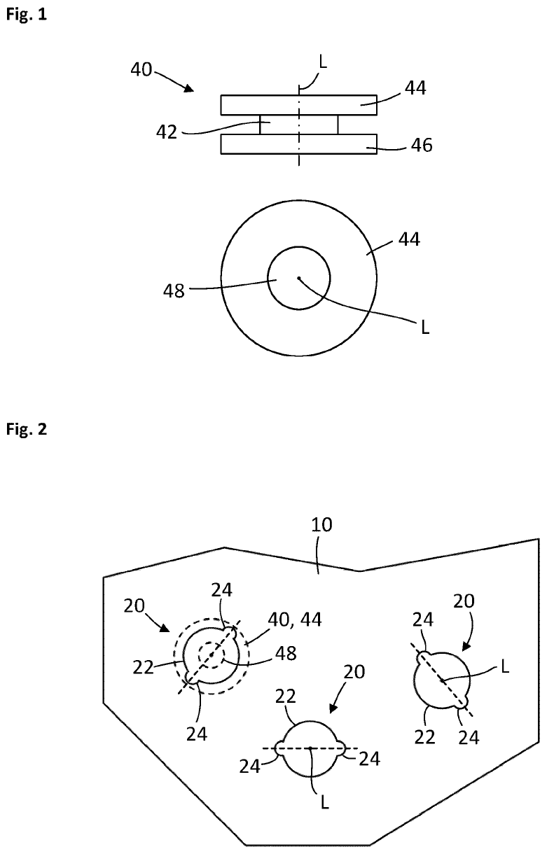

FIG. 1 shows a schematic view of a side view of an insert 40 in the upper half of the drawing. A web 42, which has a first functional portion 44 and a second functional portion 46 at the end sides, can be seen. The insert 40 extends along a longitudinal axis L. In the lower half of the image, the insert is depicted tilted downward by 90°, so that a cavity 48 extending along the longitudinal axis L can be seen here. This cavity is used, for example, to position a fastening means, such as a screw, or to guide elements, such as, for example, cables, in particular power cables or the like, through. Both the first functional portion 44 and the second functional portion 46 have the same configuration in the present case, and in particular are thus also the same size.

FIG. 2 shows a plan view of a diagram of a component 10 comprising three openings 20, which each have extensions 24 formed in pairs. It can be seen in particular that the openings 20 each have a basic shape 22, which can be referred to as circular. The extensions 24 extend radially away from this basic shape in such a manner that the diameter of the basic shape 22 is radially extended in certain regions. This advantageously makes it possible to guide a functional portion of an insert, as included in the diagram in FIG. 1, for example, through a pair of extensions of this kind.

The positioning of an insert 40 is schematically depicted in the left-hand opening 20, see the positioned first functional portion 44, in dashed lines, which covers the extensions 24 of the corresponding opening 20. A cavity 48 of the insert is also included in the diagram, this cavity extending perpendicular to the plane of the drawing and along a longitudinal axis L. It can be seen that the extensions 24 are each offset relative to one another by an angular offset, in the present case of 180°. This expediently makes it possible to prevent an undesired longitudinal or rotational movement of the component when the inserts are used to position fastening means. Expediently, the diameter of the opening 20 can be radially extended in certain regions by the extensions. In other words, the basic shape 22 is radially extended in certain regions, as a result of which an insert, such as a grommet or a cable bushing, for example, can advantageously be threaded without excessive squashing. Simultaneously, the basic shape 22 ensures that the insert is centered in the opening. For installation, the insert, which is expediently manufactured from an elastically deformable material, in particular a suitable plastic or rubber material, is lightly pressed together. The insert can be inserted in this manner halfway into the opening, the part still on the outside is swiveled in and is completely fitted into the opening by means of light pressure from above.

### LIST OF REFERENCE SIGNS

10 component
20 opening
22 basic shape
24 extension
40 insert, insert
42 web
44 first functional portion
46 second functional portion
48 cavity
L longitudinal axis, central axis

1.-10. (canceled)

11. A component, comprising:
at least one opening in the component, the component having two sides;
an insert which is positionable in the opening,
wherein the insert has a web and, at a first end, a first functional portion and, at a second end, a second functional portion,
wherein the first and second functional portions are, respectively, configured to bear against a respective side of the component,
wherein the web protrudes through the opening,
wherein the opening has a basic shape, which is adapted to a cross-sectional shape of the web, and
wherein extensions, formed in pairs, extend radially away from the basic shape of the opening such that a diameter of the basic shape is enlarged in certain regions, whereby at least the first functional portion is guidable through the opening for positioning the insert.

12. The component according to claim 11, wherein the extensions are formed opposite one another.

13. The component according to claim 11, wherein the extensions have a semi-circular shape.

14. The component according to claim 11, wherein the functional portions at the first and second ends are plate-shaped.

15. The component according to claim 11, wherein the first and second functional portions cover the extensions.

16. The component according to claim 11, wherein a plurality of pairs of extensions are formed.

17. The component according to claim 11, wherein the insert has at least one cavity extending along a longitudinal axis.

18. The component according to claim 11, wherein
the component has a plurality of openings, each comprising a pair of extensions, and
the extensions positioned in pairs are each oriented differently.

19. The component according to claim 11, wherein the component is a motor vehicle.

20. A motor vehicle comprising at least one component according to claim 11.
